(19) United States
(12) Patent Application Publication
(10) Pub. No.: US 2025/0296403 A1
(43) Pub. Date: Sep. 25, 2025

(54) VEHICLE HEAT PUMP SYSTEM

(71) Applicant: Hanon Systems, Daejeon (KR)

(72) Inventors: Dong Won LEE, Daejeon (KR); Jin Hyeong LEE, Daejeon (KR); Hyun Kwon JUNG, Daejeon (KR)

(73) Assignee: Hanon Systems, Daejeon (KR)

(21) Appl. No.: 19/070,418

(22) Filed: Mar. 4, 2025

(30) Foreign Application Priority Data
Mar. 21, 2024 (KR) 1020240039318

(51) Int. Cl. B60H 1/00

(52) U.S. Cl. CPC B60H 1/00907

(57) ABSTRACT

A vehicle heat pump system is disclosed. A vehicle heat pump system, which heat-exchanges a first heat exchange medium discharged from a compressor with a second heat exchange medium, includes a first air conditioning module disposed in a front seat region of a vehicle and including a first evaporator and a first inner heat exchanger, a second air conditioning module disposed in a rear seat region of the vehicle and including a second evaporator and a second inner heat exchanger, and a branch valve which guides a movement direction of the first heat exchange medium, and the branch valve includes a four-way branch valve which guides the first heat exchange medium discharged from the compressor to flow or not flow toward the second inner heat exchanger according to an air conditioning mode.

### CROSS-REFERENCE TO RELATED APPLICATION

This application claims priority to and the benefit of Korean Patent Application No. 10-2024-0039318, filed on Mar. 21, 2024, the disclosure of which is incorporated herein by reference in its entirety.

### BACKGROUND

### 1. Field of the Invention

The present invention relates to a vehicle heat pump system.

### 2. Discussion of Related Art

A heat pump system has a cycle in which a liquid refrigerant evaporates in an evaporator, absorbs heat from the surroundings, and becomes a gas, and the gas is liquified by a condenser by releasing heat to the surroundings. When applied to an electric vehicle or hybrid vehicle, the heat pump system has an advantage of securing a heat source that is insufficient in the conventional air conditioner.

Such a heat pump system transfers a refrigerant to a front seat air conditioner disposed in a front seat region of a vehicle and a rear seat air conditioner disposed in a rear seat region of the vehicle. That is, a line for transferring the refrigerant to a rear seat of the vehicle should be installed in the conventional heat pump system.

In this case, a heater for heating the vehicle can be provided in each of the front seat air conditioner and the rear seat air conditioner. Accordingly, in a cooling mode of the vehicle, both the front seat air conditioner and the rear seat air conditioner cool air using the refrigerant, and in a heating mode of the vehicle, both the front seat air conditioner and the rear seat air conditioner heat the air using the heater.

However, referring to FIG. 1, in the conventional heat pump system, a condenser in which a refrigerant flows in a heating mode of a vehicle is installed in only a front seat air conditioner, and only an evaporator is installed in a rear seat air conditioner without a condenser. Accordingly, in the front seat air conditioner, an amount of energy for heating the air by a heater using the condenser can be minimized, but in the rear seat air conditioner, there is a problem that a pipe through which the refrigerant is transferred from a compressor becomes long. Accordingly, the rear seat air conditioner of the conventional heat pump system heats the air using the heater. Since the air should be heated using only the heater, there are problems that the heater is overused and degrades energy use efficiency and heating efficiency.

### SUMMARY OF THE INVENTION

The present invention is directed to providing a vehicle heat pump system improved such that heating efficiency of an air conditioner installed in a rear seat region of a vehicle is increased.

According to an aspect of the present invention, there is provided a vehicle heat pump system which heat-exchanges a first heat exchange medium discharged from a compressor with a second heat exchange medium, the vehicle heat pump system including a first air conditioning module disposed in a front seat region of a vehicle and including a first evaporator and a first inner heat exchanger and a second air conditioning module disposed in a rear seat region of the vehicle and including a second evaporator and a second inner heat exchanger, wherein the first heat exchange medium passing through the second inner heat exchanger flows into the second evaporator.

The vehicle heat pump system may include a branch valve which guides the first heat exchange medium discharged from the compressor to flow or not flow toward the second inner heat exchanger according to an air conditioning mode, wherein the branch valve may be disposed between the compressor and the first air conditioning module.

The vehicle heat pump system may include a medium line which connects the compressor, the first air conditioning module, the second air conditioning module, and the branch valve and forms a movement path of the first heat exchange medium.

The medium line may include a first line which guides the first heat exchange medium discharged from the compressor to flow toward the first inner heat exchanger, a second line which guides the first heat exchange medium guided by the first line to flow toward the branch valve, and a third line which guides the first heat exchange medium arriving at the branch valve to flow toward the first air conditioning module or the second air conditioning module.

The vehicle heat pump system may include an expansion valve including a first expansion valve disposed between the branch valve and the first air conditioning module and a second expansion valve disposed behind the second air conditioning module in a flow direction of the first heat exchange medium, wherein the medium line may include a fourth line which guides the first heat exchange medium arriving at the second inner heat exchanger to flow toward the second expansion valve and a fifth line which guides the first heat exchange medium passing through the second expansion valve to flow toward the second evaporator.

The branch valve may guide the first heat exchange medium to flow toward each of the first expansion valve and the second expansion valve in a cooling mode.

The first heat exchange medium discharged from the compressor may pass through the first line and the second line and arrive at the branch valve in a heating mode.

The branch valve may guide the first heat exchange medium to flow toward the second inner heat exchanger in a heating mode.

The first heat exchange medium passing through the branch valve may pass through the second expansion valve and flow toward the second evaporator.

The vehicle heat pump system may include an outdoor heat exchanger which heat-exchanges the first heat exchange medium that has passed through the first inner heat exchanger with the second heat exchange medium, wherein the branch valve may receive the first heat exchange medium that has passed through the outdoor heat exchanger in a cooling mode.

The branch valve may include a first inlet which receives the first heat exchange medium that has passed through the outdoor heat exchanger, a second inlet which receives the first heat exchange medium that has passed through the second line of the medium line, a first outlet which guides the first heat exchange medium passing through the first inlet to flow toward the first expansion valve in the cooling mode, and a second outlet which guides the first heat exchange medium passing through the first inlet to flow toward the second expansion valve in the cooling mode and guides the first heat exchange medium that has passed through the second inlet to flow toward the second expansion valve in a heating mode.

The vehicle heat pump system may include a water condenser and an outdoor heat exchanger disposed behind the first inner heat exchanger in a flow direction of the first heat exchange medium, wherein the first heat exchange medium that has passed through the first inner heat exchanger may pass through the water condenser or the outdoor heat exchanger and flow into the first evaporator, and the first heat exchange medium that has passed through the second inner heat exchanger may flow into the second evaporator.

The vehicle heat pump system may include a first line disposed between the compressor and the first inner heat exchanger, a second line which is connected to the first line and through which the first heat exchange medium flowing through the first line branches off, and a branch valve connected to the second line, wherein the second line and the branch valve are disposed in front of the second inner heat exchanger.

The first heat exchange medium discharged from the compressor sequentially may pass through the first line, the first inner heat exchanger, the water condenser, and the outdoor heat exchanger and flow back into the compressor in a heating mode.

The first heat exchange medium discharged from the compressor may sequentially pass through the first line, the second line, the branch valve, the second inner heat exchanger, and the second evaporator and flow back into the compressor in a heating mode.

The first heat exchange medium discharged from the compressor may sequentially pass through the first line, the first inner heat exchanger, the water condenser, the outdoor heat exchanger, the branch valve, and the first evaporator and flow back into the compressor in a cooling mode.

The first heat exchange medium discharged from the compressor may sequentially pass through the first line, the first inner heat exchanger, the water condenser, the outdoor heat exchanger, the branch valve, the second inner heat exchanger, and the second evaporator and flow back into the compressor in a cooling mode.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration diagram illustrating a conventional heat pump system;

FIG. 2 is a configuration diagram illustrating a vehicle heat pump system according to an embodiment of the present invention and illustrates the flow of a first heat exchange medium in a cooling mode;

FIG. 3 is a configuration diagram illustrating the vehicle heat pump system according to the embodiment of the present invention and illustrates the flow of the first heat exchange medium in a heating mode;

FIG. 4 is a configuration diagram illustrating a vehicle heat pump system according to another embodiment of the present invention and illustrates the flow of a first heat exchange medium in a cooling mode; and

FIG. 5 is a configuration diagram illustrating the vehicle heat pump system according to another embodiment of the present invention and illustrates the flow of the first heat exchange medium in a heating mode.

### DETAILED DESCRIPTION OF EXEMPLARY EMBODIMENTS

Hereinafter, exemplary embodiments of the present invention will be described in detail with reference the accompanying drawings.

However, the technical spirit of the present invention is not limited to some embodiments which will be described and may be implemented in a variety of different forms, and one or more components of the embodiments may be selectively combined, substituted, and used within the range of the technical spirit of the present invention.

In addition, unless clearly and specifically defined otherwise by the context, all terms (including technical and scientific terms) used herein can be interpreted as having meanings customarily understood by those skilled in the art, and the meanings of generally used terms, such as those defined in commonly used dictionaries, will be interpreted in consideration of contextual meanings of the related art.

In addition, terms used in the embodiments of the present invention are considered in a descriptive sense only and not to limit the present invention.

In the present specification, unless specifically indicated otherwise by the context, singular forms include plural forms, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” may be used.

Such terms are only to distinguish one component from another component, and the essence, order, and the like of the components are not limited by the terms.

In addition, it should be understood that, when a first component is referred to as being “connected,” “coupled,” or “linked” to a second component, such a description may include both a case in which the first component is directly connected, coupled, or linked to the second component and a case in which the first component is connected or coupled to the second component with a third component disposed therebetween.

In addition, when a first component is described as being formed or disposed “on (above)” or “under (below)” a second component, such a description includes both a case in which the two components are formed or disposed in direct contact with each other and a case in which one or more other components are interposed between the two components. In addition, when the first component is described as being formed “on (above) or under (below)” the second component, such a description may include a case in which the first component is formed at an upper side or a lower side with respect to the second component.

Hereinafter, a vehicle heat pump system will be described in detail with reference to the accompanying drawings, and in the description with reference to the accompanying drawings, components which are the same or correspond to each other will be denoted by the same reference numerals, and redundant description thereof will be omitted.

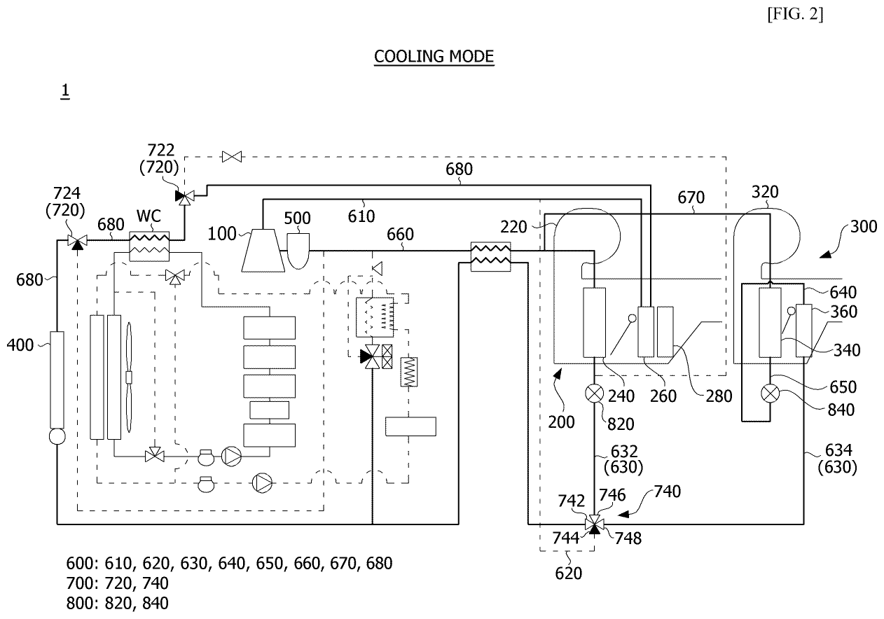

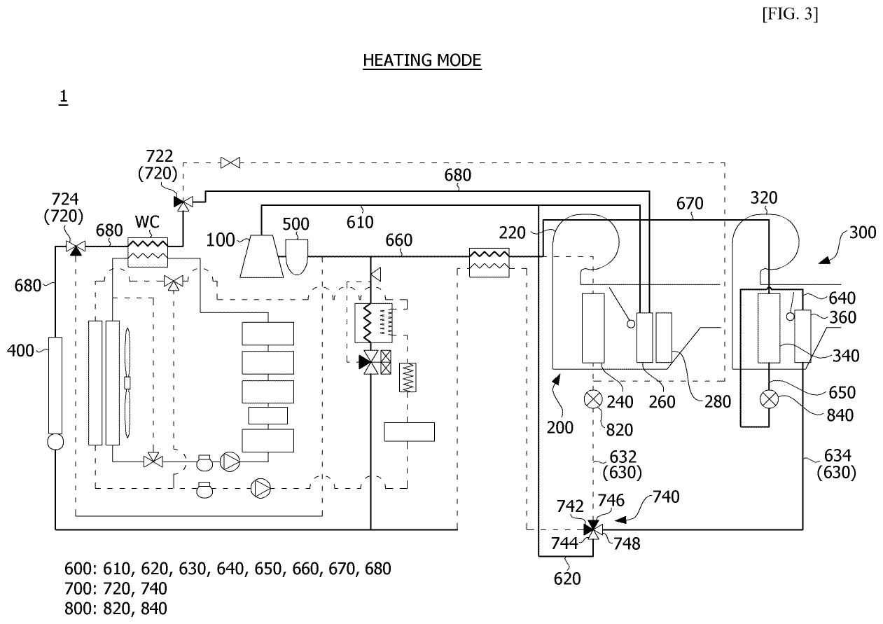

FIG. 2 is a configuration diagram illustrating a vehicle heat pump system according to an embodiment of the present invention and illustrates the flow of a first heat exchange medium in a cooling mode, and FIG. 3 is a configuration diagram illustrating the vehicle heat pump system according to the embodiment of the present invention and illustrates the flow of the first heat exchange medium in a heating mode.

Referring to FIGS. 2 and 3, a vehicle heat pump system 1 according to the embodiment of the present invention may heat-exchange a first heat exchange medium discharged from a compressor 100 with a second heat exchange medium. In this case, the first heat exchange medium may include a refrigerant, and the second heat exchange medium may include air. Accordingly, hereinafter, the first heat exchange medium is called a first heat exchange medium and a refrigerant, and the second heat exchange medium is called as a second heat exchange medium and air.

The vehicle heat pump system 1 may include a compressor 100, a first air conditioning module 200, a second air conditioning module 300, an outdoor heat exchanger 400, an accumulator 500, a medium line 600, a branch valve 700 and an expansion valve 800.

The compressor 100 may compress the refrigerant. The compressor 100 may discharge the refrigerant in a high-temperature and high-pressure gaseous state. In this case, the compressor 100 may be called a compressor.

The first air conditioning module 200 may be disposed in a front seat region of a vehicle. Accordingly, the first air conditioning module 200 may discharge air-conditioned air toward the front seat region of the vehicle. The first air conditioning module 200 may include a first case 220, a first evaporator 240, a first inner heat exchanger 260, and a heater 280.

The first case 220 may accommodate the first evaporator 240, the first inner heat exchanger 260, and the heater 280 therein. A discharge port through which cooled or heated air is discharged may be formed in the first case 220.

The first evaporator 240 may be disposed in the first case 220. The first evaporator 240 may receive the refrigerant that has passed through the outdoor heat exchanger 400 and a first expansion valve 820, which will be described below, in the cooling mode of the vehicle. Air passing through the first evaporator 240 in the cooling mode of the vehicle may be cooled by exchanging heat with the refrigerant accommodated in the first evaporator 240. In addition, the first evaporator 240 in the heating mode of the vehicle may be used as a path through which air introduced into the first case 220 passes.

The first inner heat exchanger 260 may be disposed in the first case 220. The first inner heat exchanger 260 may be disposed apart from the first evaporator 240 in the first case 220. The first inner heat exchanger 260 may cool the high-temperature and high-pressure refrigerant discharged from the compressor 100 such that the refrigerant becomes a liquid. In this case, the first inner heat exchanger 260 may be called a first condenser.

A mode door may be disposed between the first evaporator 240 and the first inner heat exchanger 260. The mode door may rotate according to an air conditioning mode of the vehicle. For example, the mode door in the cooling mode may guide the air introduced into the first case 220 to not flow toward the first inner heat exchanger 260, and the mode door in the heating mode may guide the air introduced into the first case 220 to flow from the first evaporator 240 toward the first inner heat exchanger 260.

The heater 280 may be disposed in the first case 220 and disposed in front of the first inner heat exchanger 260 in an air flow direction. The heater 280 may operate in the heating mode of the vehicle and heat-exchange air to heat the air passing through the first inner heat exchanger 260.

The second air conditioning module 300 may be disposed in a rear seat region of the vehicle. Accordingly, the second air conditioning module 300 may discharge air-conditioned air toward the rear seat region of the vehicle. The second air conditioning module 300 may include a second case 320, a second evaporator 340, and a second inner heat exchanger 360.

The second case 320 may accommodate the second evaporator 340 and the second inner heat exchanger 360 therein. A discharge port through which cooled or heated air is discharged may be formed in the second case 320.

The second evaporator 340 may be disposed in the second case 320. The second evaporator 340 may receive the refrigerant that has passed through the second inner heat exchanger 360 and a second expansion valve 840, which will be described below, in the cooling mode and heating mode of the vehicle. Air passing through the second evaporator 340 in the cooling mode of the vehicle may be cooled by exchanging heat with the refrigerant accommodated in the second evaporator 340. In addition, the second evaporator 340 in the heating mode of the vehicle may be used as a path through which the air introduced into the second case 320 passes.

The second inner heat exchanger 360 may be disposed in the second case 320. The second inner heat exchanger 360 may be disposed apart from the second evaporator 340 in the second case 320. The second inner heat exchanger 360 may accommodate the refrigerant passing through the outdoor heat exchanger 400. In this case, the second inner heat exchanger 360 may be called a second condenser.

A mode door may be disposed between the second evaporator 340 and the second inner heat exchanger 360. The mode door may rotate according to the air conditioning mode of the vehicle. For example, the mode door in the cooling mode may guide the air introduced into the second case 320 to not flow toward the second inner heat exchanger 360, and the mode door in the heating mode may guide the air introduced into the second case 320 to flow from the second evaporator 340 toward the second inner heat exchanger 360.

The outdoor heat exchanger 400 may be provided on the front side of the vehicle. The outdoor heat exchanger 400 may receive the refrigerant that has passed through the first inner heat exchanger 260 of the first air conditioning module 200. The outdoor heat exchanger 400 may heat-exchange the first heat exchange medium (refrigerant) that has passed through the first inner heat exchanger 260 with the second heat exchange medium (air).

In this case, a water condenser WC which allows the first heat exchange medium (refrigerant) to cross a third heat exchange medium (water) to heat-exchange the first heat exchange medium (refrigerant) with the third heat exchange medium (water) may be disposed between the first inner heat exchanger 260 and the outdoor heat exchanger 400.

The accumulator 500 may be disposed behind the compressor 100 in a flow direction of the refrigerant. The accumulator 500 may receive the refrigerant that has passed through the first evaporator 240 of the first air conditioning module 200 and the second evaporator 340 of the second air conditioning module 300 in the cooling mode of the vehicle. In addition, the accumulator 500 may receive the refrigerant that has passed through the second evaporator 340 of the second air conditioning module 300 in the heating mode of the vehicle. The accumulator 500 may selectively discharge the refrigerant in a liquid state and the refrigerant in a gaseous state. The accumulator 500 may be called an accumulator.

The medium line 600 may connect the compressor 100, the first air conditioning module 200, the second air conditioning module 300, and a four-way branch valve 740 which will be described below and may form a movement path of the first heat exchange medium (refrigerant). The medium line 600 may include a first line 610, a second line 620, a third line 630, a fourth line 640, a fifth line 650, a sixth line 660, a seventh line 670, and an eighth line 680.

The first line 610 may guide the first heat exchange medium discharged from the compressor 100 to flow toward the first inner heat exchanger 260. The second line 620 may guide the first heat exchange medium guided by the first line 610 to flow toward the four-way branch valve 740. In this case, the second line 620 may be connected to one region of the first line 610.

The third line 630 may guide the first heat exchange medium arriving at the four-way branch valve 740 to flow toward the first air conditioning module 200 or the second air conditioning module 300. The third line 630 may include a 3-1 line 632 which guides the first heat exchange medium to flow from the four-way branch valve 740 toward the first air conditioning module 200 and a 3-2 line 634 which guides the first heat exchange medium to flow from the four-way branch valve 740 toward the second air conditioning module 300.

The fourth line 640 may guide the first heat exchange medium arriving at the second inner heat exchanger 360 to flow toward the second expansion valve 840. The fifth line 650 may guide the first heat exchange medium passing through the second expansion valve 840 toward the second evaporator 340. The sixth line 660 may guide the first heat exchange medium passing through the first evaporator 240 to flow toward the accumulator 500. The seventh line 670 may guide the first heat exchange medium passing through the second evaporator 340 to flow toward the accumulator 500. The seventh line 670 may be connected to the sixth line 660. Accordingly, the refrigerant flowing through the seventh line 670 may be introduced into the sixth line 660 and introduced into the accumulator 500 and compressor 100.

The eighth line 680 may be provided as a plurality of eighth lines 680. The eighth lines 680 may connect the first inner heat exchanger 260 and a first valve 722 of a three-way branch valve 720 which will be described below, connect the first valve 722 of the three-way branch valve 720 and a second valve 724, connect the second valve 724 of the three-way branch valve 720 and the outdoor heat exchanger 400, and the outdoor heat exchanger 400 and the four-way branch valve 740.

The branch valve 700 may guide a movement direction of the first heat exchange medium. The branch valve 700 may be disposed on the medium line 600. The branch valve 700 may include the three-way branch valve 720 and the four-way branch valve 740.

The three-way branch valve 720 may be disposed behind the outdoor heat exchanger 400 in the flow direction of the refrigerant. The three-way branch valve 720 may receive the refrigerant discharged from the first inner heat exchanger 260 of the first air conditioning module 200. The three-way branch valve 720 may include the first valve 722 and the second valve 724.

The first valve 722 may set the movement direction of the refrigerant discharged from the first inner heat exchanger 260 of the first air conditioning module 200. The first valve 722 may adiabatically expand the high-temperature and high-pressure refrigerant, which has passed through the first inner heat exchanger 260, into a low-temperature and low-pressure state. The second valve 724 may be disposed in front of the first valve 722 in the flow direction of the refrigerant. The second valve 724 may set the movement direction of the refrigerant passing through the first valve 722.

The four-way branch valve 740 may guide the first heat exchange medium discharged from the compressor 100 to flow or not flow toward the second inner heat exchanger 360 according to the air conditioning mode. The four-way branch valve 740 may include a first inlet 742, a second inlet 744, a first outlet 746, and a second outlet 748. Each component of the four-way branch valve 740 may be disposed to rotate 90° but is not limited thereto.

The first inlet 742 may be connected to the fifth line 650 of the medium line 600. The first inlet 742 may receive the first heat exchange medium that has passed through the outdoor heat exchanger 400. The second inlet 744 may be connected to the second line 620 of the medium line 600. The second inlet 744 may receive the first heat exchange medium that has passed through the second line 620 of the medium line 600.

The first outlet 746 may be connected to the 3-1 line 632 of the medium line 600. The first outlet 746 may guide the first heat exchange medium passing through the first inlet 742 to flow toward the first expansion valve 820 in the cooling mode of the vehicle.

The second outlet 748 may be connected to the 3-2 line 634 of the medium line 600. The second outlet 748 may guide the first heat exchange medium passing through the first inlet 742 to flow toward the second expansion valve 840 in the cooling mode of the vehicle and guide the first heat exchange medium passing through the second inlet 744 to flow toward the second expansion valve 840 in the heating mode of the vehicle.

The four-way branch valve 740 may be disposed between the compressor 100 and the first air conditioning module 200. Accordingly, since the second air conditioning module 300 can cool or heat air using a refrigerant, the need for exchanging heat in the rear seat region of the vehicle using an additional refrigerant and an additional heat exchange medium other than air can be reduced. Accordingly, the maintenance costs of the vehicle heat pump system 1 can be reduced.

The four-way branch valve 740 may guide the first heat exchange medium to flow toward each of the first expansion valve 820 and the second expansion valve 840 in the cooling mode. Particularly, the four-way branch valve 740 may guide the refrigerant, which is the first heat exchange medium, to flow toward the second expansion valve 840. Accordingly, since the refrigerant passes through the second expansion valve 840 before flowing toward the second evaporator 340, the air can be easily cooled by the refrigerant accommodated in the second evaporator 340.

In the cooling mode of the vehicle, the four-way branch valve 740 may receive the first heat exchange medium that has passed through the outdoor heat exchanger 400. More specifically, an open state of the first inlet 742 of the four-way branch valve 740 may be maintained in the cooling mode. In addition, the first heat exchange medium discharged from the compressor 100 may pass through the first line 610 and the second line 620 of the medium line 600 and arrive at the four-way branch valve 740 in the heating mode.

The four-way branch valve 740 may prevent the flow of refrigerant from being delayed by guiding the refrigerant to flow toward the expansion valve 800 in the cooling mode and the heating mode of the vehicle. Accordingly, the cooling and heating efficiency of the vehicle heat pump system 1 can be maintained.

In addition, the four-way branch valve 740 may guide the first heat exchange medium to flow toward the second inner heat exchanger 360 in the heating mode of the vehicle. Accordingly, in the heating mode of the vehicle, the refrigerant, which is the first heat exchange medium, may be prevented from flowing toward the first expansion valve 820, and the refrigerant flowing toward the second air conditioning module 300 may be prevented from being delayed, so that the air heating performance of the second air conditioning module 300 can be maintained.

The expansion valve 800 may adiabatically expand the refrigerant, which flows toward the first evaporator 240 and the second evaporator 340, into a low-temperature and low-pressure state in the cooling mode of the vehicle. In addition, the expansion valve 800 may adiabatically expand the refrigerant, which has passed through the second inner heat exchanger 360, into a low-temperature and low-pressure state to flow toward the accumulator 500 in the heating mode of the vehicle. The expansion valve 800 may include the first expansion valve 820 disposed between the four-way branch valve 740 and the first air conditioning module 200 and the second expansion valve 840 disposed behind the second air conditioning module 300 in the flow direction of the first heat exchange medium.

The first heat exchange medium passing through the four-way branch valve 740 may pass through the second expansion valve 840 and flow toward the second evaporator 340. Accordingly, in the cooling mode of the vehicle, the refrigerant in the low-temperature and low-pressure state may be discharged toward the second evaporator 340 to facilitate cooling of the second evaporator 340. In addition, the refrigerant passing through the second expansion valve 840 may be changed to a low-pressure state such that the accumulator 500 is able to easily perform gas/liquid separation.

Hereinafter, the flow of the refrigerant according to the air conditioning mode of the vehicle will be described.

Referring to FIG. 2, in the cooling mode of the vehicle, the refrigerant is discharged from the compressor 100 and moves to the first inner heat exchanger 260 of the first air conditioning module 200 through the first line 610 of the medium line 600. The refrigerant moved to the first inner heat exchanger 260 sequentially passes through the first valve 722 and the second valve 724 of the three-way branch valve 720 through the eighth line 680 of the medium line 600 and moves to the four-way branch valve 740 through the outdoor heat exchanger 400.

The refrigerant arriving at the four-way branch valve 740 passes through the first outlet 746 and the 3-1 line 632 of the medium line 600, moves toward the first expansion valve 820, passes through the second outlet 748 and the 3-2 line 634 of the medium line 600, and moves toward the second inner heat exchanger 360 of the second air conditioning module 300.

First, the refrigerant arriving at the first expansion valve 820 is changed to a low-temperature and low-pressure state by the first expansion valve 820 and flows into the first evaporator 240. The refrigerant introduced into the first evaporator 240 is heat-exchanged with air, flows into the accumulator 500 through the sixth line 660 of the medium line 600, and finally flows back into the compressor 100.

Then, the refrigerant arriving at the second inner heat exchanger 360 of the second air conditioning module 300 passes through the fourth line 640 of the medium line 600 and arrives at the second expansion valve 840. The refrigerant arriving at the second expansion valve 840 is changed to a low-temperature and low-pressure state by the second expansion valve 840 and flows into the second evaporator 340. The refrigerant introduced into the second evaporator 340 is heat-exchanged with air, flows into the accumulator 500 through the seventh line 670 and the sixth line 660 of the medium line 600 and finally flows back into the compressor 100.

Referring to FIG. 3, in the heating mode of the vehicle, the refrigerant is discharged from the compressor 100 and moved to the first inner heat exchanger 260 of the first air conditioning module 200 through the first line 610 of the medium line 600. In addition, the refrigerant discharged from the compressor 100 moves to the four-way branch valve 740 through the second line 620 connected to the first line 610 of the medium line 600.

First, the refrigerant moved to the first inner heat exchanger 260 sequentially passes through the first valve 722 and the second valve 724 of the three-way branch valve 720 through the fifth line 650 of the medium line 600. In this case, the refrigerant is changed to a low-temperature and low-pressure state while passing through the first valve 722 of the three-way branch valve 720. The refrigerant sequentially passing through the first valve 722 and the second valve 724 of the three-way branch valve 720 flows into the accumulator 500 through the outdoor heat exchanger 400 and finally flows back into the compressor 100.

Then, the refrigerant arriving at the four-way branch valve 740, more specifically, at the second inlet 744 of the four-way branch valve 740, passes through the 3-2 line 634 of the medium line 600 and moves toward the second inner heat exchanger 360 of the second air conditioning module 300. The refrigerant introduced into the second inner heat exchanger 360 is heat-exchanged with air, passes through the fourth line 640 of the medium line 600, and arrives at the second expansion valve 840.

The refrigerant arriving at the second expansion valve 840 is changed to a low-temperature and low-pressure state by the second expansion valve 840, passes through the second evaporator 340, flows into the accumulator 500 through the seventh line 670 and the sixth line 660 of the medium line 600, and finally flows back into the compressor 100.

As described above, the vehicle heat pump system 1 according to the embodiment of the present invention may prevent a heating delay in the rear seat region of the vehicle occurring during the initial driving of the vehicle using the second inner heat exchanger 360 disposed in the rear seat region of the vehicle. Accordingly, the air-conditioning satisfaction of passengers can be improved.

In addition, in the vehicle heat pump system 1 according to the embodiment of the present invention, the use of an additional medium (electricity) can be eliminated by omitting a heater 280 disposed in a second air conditioning module 300 of the conventional heat pump system for heating a rear seat region of a vehicle. Accordingly, as only one heat exchange medium excluding air is used, the operating costs of the heat pump system can be reduced.

Hereinafter, a vehicle heat pump system 2 according to another embodiment of the present invention will be described, in the description of the vehicle heat pump system 2 according to another embodiment of the present invention, the same numerals will be assigned to the same components as those of the vehicle heat pump system 1 according to the embodiment of the present invention, and redundant description thereof will be omitted.

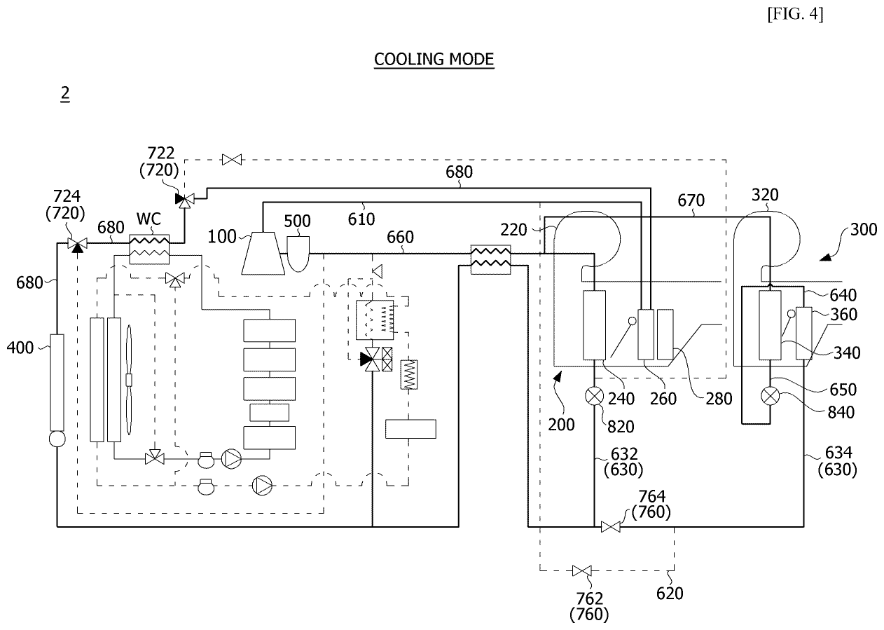

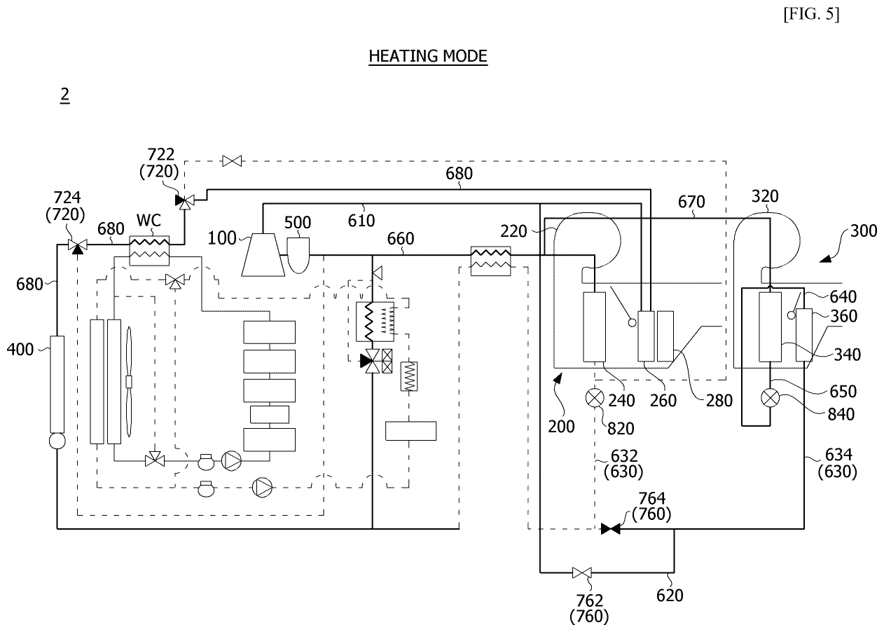

FIG. 4 is a configuration diagram illustrating the vehicle heat pump system according to another embodiment of the present invention and illustrates the flow of a first heat exchange medium in a cooling mode, and FIG. 5 is a configuration diagram illustrating the vehicle heat pump system according to another embodiment of the present invention and illustrates the flow of the first heat exchange medium in a heating mode.

Referring to FIGS. 4 and 5, the vehicle heat pump system 2 according to another embodiment of the present invention may include a compressor 100, a first air conditioning module 200, a second air conditioning module 300, an outdoor heat exchanger 400, an accumulator 500, a medium line 600, a branch valve 700, and an expansion valve 800.

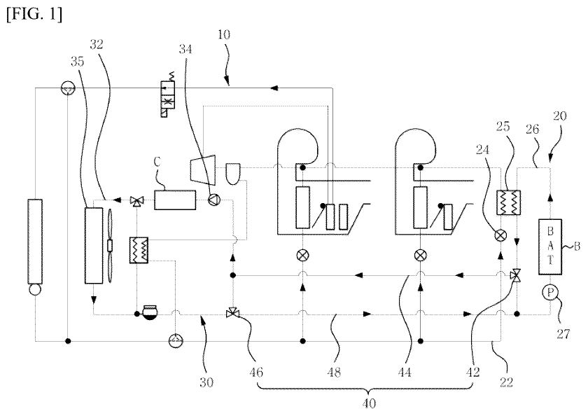

In this case, since all components excluding the branch valve 700 are the same as those of the heat pump system 1 in FIGS. 1 to 3, description thereof will be omitted.

The branch valve 700 may include a three-way branch valve 720 and a two-way branch valve 760. First, since the three-way branch valve 720 is the same as that of the heat pump system 1 in FIGS. 1 to 3, description thereof will be omitted.

The two-way branch valve 760 may guide a first heat exchange medium discharged from the compressor 100 to flow or not flow toward a second inner heat exchanger 360 according to an air conditioning mode. The two-way branch valve 760 may include a first two-way branch valve 762 and a second two-way branch valve 764.

The first two-way branch valve 762 may be disposed in one region of a second line 620 of the medium line 600. The first two-way branch valve 762 may stop the movement of the first heat exchange medium which moves along the second line 620 of the medium line 600 in the cooling mode of the vehicle. In addition, the first two-way branch valve 762 may activate a movement path of the first heat exchange medium which moves along the second line 620 of the medium line 600 such that the first heat exchange medium moves along a 3-2 line 634 of the medium line 600 in the heating mode of the vehicle.

The second two-way branch valve 764 may be disposed around a point at which a 3-1 line 632 and the 3-2 line 634 of the medium line 600 branch off (disposed behind the point at which the 3-1 line 632 and the 3-2 line 634 of the medium line 600 branch off in a flow direction of the first heat exchange medium). The second two-way branch valve 764 may activate the movement path of the first heat exchange medium such that the first heat exchange medium may move along the 3-2 line 634 of the medium line 600 to flow toward the second air conditioning module 300 in the cooling mode of the vehicle. In addition, in the heating mode of the vehicle, the movement path of the first heat exchange medium may be restricted such that the first heat exchange medium passing through the first two-way branch valve 762 does not flow toward the first air conditioning module 200.

Hereinafter, the flow of the refrigerant will be described according to the air conditioning mode of the vehicle will be described.

Referring to FIG. 4, in the cooling mode of the vehicle, the refrigerant is discharged from the compressor 100 and moved to a first inner heat exchanger 260 of the first air conditioning module 200 through a first line 610 of the medium line 600. The refrigerant moved to the first inner heat exchanger 260 sequentially passes through a first valve 722 and a second valve 724 of the three-way branch valve 720 through a eighth line 680 of the medium line 600, branches off before arriving at the second two-way branch valve 764 through the outdoor heat exchanger 400, flows toward the first air conditioning module 200 or passes through the second two-way branch valve 764, and flows toward the second air conditioning module 300.

More specifically, the branched off refrigerant passes through the 3-1 line 632 of the medium line 600 and moves toward a first expansion valve 820 before arriving at the second two-way branch valve 764, and the refrigerant passing through the second two-way branch valve 764 passes through the 3-2 line 634 of the medium line 600 and moves toward the second inner heat exchanger 360 of the second air conditioning module 300.

First, the refrigerant arriving at the first expansion valve 820 is changed to a low-temperature and low-pressure state by the first expansion valve 820 and flows into a first evaporator 240. The refrigerant introduced into the first evaporator 240 is heat-exchanged with air, flows into the accumulator 500 through a sixth line 660 of the medium line 600, and finally flows back into the compressor 100.

Then, the refrigerant arriving at the second inner heat exchanger 360 of the second air conditioning module 300 passes through a fourth line 640 of the medium line 600 and arrives at a second expansion valve 840. The refrigerant arriving at the second expansion valve 840 is changed to a low-temperature and low-pressure state by the second expansion valve 840 and flows into a second evaporator 340. The refrigerant introduced into the second evaporator 340 is heat-exchanged with air, flows into the accumulator 500 through a seventh line 670 and the sixth line 660 of the medium line 600, and finally flows back into the compressor 100.

Referring to FIG. 5, in the heating mode of the vehicle, the refrigerant discharged from the compressor 100 moves to the first inner heat exchanger 260 of the first air conditioning module 200 through the first line 610 of the medium line 600 or moves to the first two-way branch valve 762 through the second line 620 connected to the first line 610 of the medium line 600.

First, the refrigerant moved to the first inner heat exchanger 260 sequentially passes through the first valve 722 and the second valve 724 of the three-way branch valve 720 through a fifth line 650 of the medium line 600. In this case, the refrigerant is changed to a low-temperature and low-pressure state while passing through the first valve 722 of the three-way branch valve 720. The refrigerant sequentially passing through the first valve 722 and the second valve 724 of the three-way branch valve 720 flows into the accumulator 500 through the outdoor heat exchanger 400 and finally flows back into the compressor 100.

Then, the refrigerant arriving at the first two-way branch valve 762 passes through the 3-2 line 634 of the medium line 600 and moves toward the second inner heat exchanger 360 of the second air conditioning module 300. In this case, the second two-way branch valve 764 is closed such that the refrigerant does not flow toward the first air conditioning module 200 through the first two-way branch valve 762. The refrigerant flowing into the second inner heat exchanger 360 is heat-exchanged with air, passes through the fourth line 640 of the medium line 600, and arrives at the second expansion valve 840.

The refrigerant arriving at the second expansion valve 840 is changed to a low-temperature and low-pressure state by the second expansion valve 840, passes through the second evaporator 340, flows into the accumulator 500 through the seventh line 670 and sixth line 660 of the medium line 600, and finally flows back into the compressor 100.

As described above, in the vehicle heat pump system 2 according to another embodiment of the present invention, the flow direction of the refrigerant, which is the first heat exchange medium, can be guided by the first two-way branch valve 762 and the second two-way branch valve 764 in the cooling mode and the heating mode of the vehicle.

According to embodiments of the present invention, a condenser, which is the same as a condenser installed in a front seat region of a vehicle, can be installed in an air conditioning module installed in a rear seat region of the vehicle. Accordingly, a decrease in heating efficiency of a rear seat air conditioning module of the vehicle can be prevented when compared to the conventional heat pump system in which a heater is used.

While the present invention has been described above with reference to exemplary embodiments, it should be understood by those skilled in the art that various modifications and changes of the present invention may be made within a range not departing from the spirit and scope of the present invention defined by the appended claims. In addition, it should be interpreted that differences related to such modifications and changes fall within the scope of the present invention defined by the appended claims.

What is claimed is:

1. A vehicle heat pump system which heat-exchanges a first heat exchange medium discharged from a compressor with a second heat exchange medium, the vehicle heat pump system comprising:
a first air conditioning module disposed in a front seat region of a vehicle and including a first evaporator and a first inner heat exchanger; and
a second air conditioning module disposed in a rear seat region of the vehicle and including a second evaporator and a second inner heat exchanger,
wherein the first heat exchange medium passing through the second inner heat exchanger flows into the second evaporator.

2. The vehicle heat pump system of claim 1, comprising a branch valve which guides the first heat exchange medium discharged from the compressor to flow or not flow toward the second inner heat exchanger according to an air conditioning mode,
wherein the branch valve is disposed between the compressor and the first air conditioning module.

3. The vehicle heat pump system of claim 2, comprising a medium line which connects the compressor, the first air conditioning module, the second air conditioning module, and the branch valve and forms a movement path of the first heat exchange medium.

4. The vehicle heat pump system of claim 3, wherein the medium line includes:
a first line which guides the first heat exchange medium discharged from the compressor to flow toward the first inner heat exchanger;
a second line which guides the first heat exchange medium guided by the first line to flow toward the branch valve; and
a third line which guides the first heat exchange medium arriving at the branch valve to flow toward the first air conditioning module or the second air conditioning module.

5. The vehicle heat pump system of claim 4, comprising an expansion valve including a first expansion valve disposed between the branch valve and the first air conditioning module and a second expansion valve disposed behind the second air conditioning module in a flow direction of the first heat exchange medium,
wherein the medium line includes:
a fourth line which guides the first heat exchange medium arriving at the second inner heat exchanger to flow toward the second expansion valve; and
a fifth line which guides the first heat exchange medium passing through the second expansion valve to flow toward the second evaporator.

6. The vehicle heat pump system of claim 5, wherein the branch valve guides the first heat exchange medium to flow toward each of the first expansion valve and the second expansion valve in a cooling mode.

7. The vehicle heat pump system of claim 5, wherein the first heat exchange medium discharged from the compressor passes through the first line and the second line and arrives at the branch valve in a heating mode.

8. The vehicle heat pump system of claim 6, wherein the branch valve guides the first heat exchange medium to flow toward the second inner heat exchanger in a heating mode.

9. The vehicle heat pump system of claim 5, wherein the first heat exchange medium passing through the branch valve passes through the second expansion valve and flows toward the second evaporator.

10. The vehicle heat pump system of claim 5, comprising an outdoor heat exchanger which heat-exchanges the first heat exchange medium that has passed through the first inner heat exchanger with the second heat exchange medium,
wherein the branch valve receives the first heat exchange medium that has passed through the outdoor heat exchanger in a cooling mode.

11. The vehicle heat pump system of claim 10, wherein the branch valve includes:
a first inlet which receives the first heat exchange medium that has passed through the outdoor heat exchanger;
a second inlet which receives the first heat exchange medium that has passed through the second line of the medium line;
a first outlet which guides the first heat exchange medium passing through the first inlet to flow toward the first expansion valve in the cooling mode; and
a second outlet which guides the first heat exchange medium passing through the first inlet to flow toward the second expansion valve in the cooling mode and guides the first heat exchange medium that has passed through the second inlet to flow toward the second expansion valve in a heating mode.

12. The vehicle heat pump system of claim 1, comprising a water condenser and an outdoor heat exchanger disposed behind the first inner heat exchanger in a flow direction of the first heat exchange medium, wherein:
the first heat exchange medium that has passed through the first inner heat exchanger passes through the water condenser or the outdoor heat exchanger and flows into the first evaporator; and
the first heat exchange medium that has passed through the second inner heat exchanger flows into the second evaporator.

13. The vehicle heat pump system of claim 12, comprising:
a first line disposed between the compressor and the first inner heat exchanger;
a second line which is connected to the first line and through which the first heat exchange medium flowing through the first line branches off; and
a branch valve connected to the second line,
wherein the second line and the branch valve are disposed in front of the second inner heat exchanger.

14. The vehicle heat pump system of claim 13, wherein the first heat exchange medium discharged from the compressor sequentially passes through the first line, the first inner heat exchanger, the water condenser, and the outdoor heat exchanger and flows back into the compressor in a heating mode.

15. The vehicle heat pump system of claim 13, wherein the first heat exchange medium discharged from the compressor sequentially passes through the first line, the second line, the branch valve, the second inner heat exchanger, and the second evaporator and flows back into the compressor in a heating mode.

16. The vehicle heat pump system of claim 13, wherein the first heat exchange medium discharged from the compressor sequentially passes through the first line, the first inner heat exchanger, the water condenser, the outdoor heat exchanger, the branch valve, and the first evaporator and flows back into the compressor in a cooling mode.

17. The vehicle heat pump system of claim 13, wherein the first heat exchange medium discharged from the compressor sequentially passes through the first line, the first inner heat exchanger, the water condenser, the outdoor heat exchanger, the branch valve, the second inner heat exchanger, and the second evaporator and flows back into the compressor in a cooling mode.
